(19) United States
(12) Patent Application Publication
(10) Pub. No.: US 2011/0107568 A1
(43) Pub. Date: May 12, 2011

(54) CASKET VAULT

(75) Inventor: Ilija Rojdev, Cincinnati, OH (US)

(73) Assignee: Batesville Services, Inc., Batesville, IN (US)

(21) Appl. No.: 12/615,092

(22) Filed: Nov. 9, 2009

(51) Int. Cl. A61G 99/00

(52) U.S. Cl. 27/35

(57) ABSTRACT

A casket vault comprises a base adapted to receive therein a casket containing remains of a deceased and a lid closable on the base. It can include a pair of wheels mounted to the base facilitating transport of the casket vault, a pair of handles formed in either or both of the base and lid facilitating transport of the casket vault, at least a pair of slots formed in an outward side of a bottom wall of the base adapted to receive and position lowering straps for lowering the casket vault into a grave and for facilitating removal of the straps from the casket vault after the casket vault has been completely lowered into the grave, a memorial record tube assembly disposed in the lid for containing a record of identification of a deceased in the casket vault, a pair of gaskets disposed between flanges of the base and lid, one gasket being a peripherally inner gasket and the other gasket being a peripherally outer gasket, fasteners positioned between the peripherally inner and outer gaskets securing the lid on the base, an extension extending peripherally outwardly from one or more of the bottom wall, one (or both) of the side walls, and one (or both) of the end walls to anchor the casket vault in a grave, and/or a cable ledge extending across each end wall and adapted to receive a length of cable positioned thereunder such that the cable can be used to raise the casket vault.

### RELATED APPLICATIONS

None.

### FIELD

The subject matter herein relates generally to funerary products and more particularly to vaults for caskets.

### BACKGROUND

For in-ground interment of the body of a deceased, the body is placed in a casket which is then buried in a grave. The casket may be placed in a vault in the grave if greater protection for the casket and body is desired.

Casket vaults may be fabricated from concrete or synthetic resinous material. Examples of casket vaults fabricated from synthetic resinous material are shown in U.S. Pat. No. 5,245,733 for Combination Burial Vault/Casket, U.S. Pat. No. 5,321,873 for Burial Container, and U.S. Pat. No. 6,282,763 for Burial Container And Methods Of Making, all of which are hereby incorporated by reference herein as if fully set forth in their entirety.

Further innovation in casket vaults is desired.

### SUMMARY

In one aspect, a casket vault comprises a base adapted to receive therein a casket containing remains of a deceased, a lid closable on the base, and a pair of wheels mounted to the base facilitating transport of the casket vault.

The base and lid can be of a double wall construction each having an inner wall and an outer wall. The base and lid can have a structural filler material between the inner and outer walls. The inner and outer walls of the base and lid can be fabricated of a synthetic resinous material. The structural filler material can be structural foam. The base can include an end wall and a bottom wall; a pair of wheel wells can be formed in the end and bottom walls, and one of the pair of wheels can be mounted in each of the wheel wells. Alternatively, the base can include a pair of side walls, an end wall, and a bottom wall, and one of the pair of wheels can be mounted outboard of each of the side walls.

In another aspect, a casket vault comprises a base adapted to receive therein a casket containing remains of a deceased, a lid closable on the base, and a pair of handles formed in either the base or the lid (or both) facilitating transport of the casket vault.

The handles can be integrally formed as a fixed part of the base or lid, or alternatively, the handles can be pivoted to the base or the lid. The handles can pivot into and out of recesses formed in the base or lid. The handles have an outward surface contour that matches an outward surface contour of the base or lid when said handles are pivoted into the recesses.

In another aspect, a casket vault comprises a base adapted to receive therein a casket containing remains of a deceased, a lid closable on the base, and at least a pair of slots formed in an outward side of a bottom wall of the base adapted to receive and position lowering straps for lowering the casket vault into a grave and for facilitating removal of the straps from the casket vault after the casket vault has been completely lowered into the grave.

The slots can run perpendicular to a lengthwise dimension of the of casket vault. There can be three such slots. Alternatively, the slots can run parallel to the lengthwise dimension of the casket vault. There can be two such slots. Alternatively, the slots can run perpendicular to a lengthwise dimension of the casket vault and parallel to the lengthwise dimension of the of casket vault. There can be three slots running perpendicular to the lengthwise dimension of the casket vault and two slots running parallel to the lengthwise dimension of the of casket vault.

In another aspect, a casket vault comprises a base adapted to receive therein a casket containing remains of a deceased, a lid closable on the base, and a memorial record tube assembly disposed in the lid for containing a record of identification of a deceased in the casket vault.

The memorial record tube assembly can comprise a cylinder disposed in the lid, a memorial record tube including a threaded cap disposed in the cylinder, and a nameplate overlying the memorial record tube assembly.

In another aspect, a casket vault comprises a base adapted to receive therein a casket containing remains of a deceased, the base having an upwardly facing flange, a lid closable on the base, the lid having an downwardly facing flange, a pair of gaskets disposed between the flanges of the base and lid, one gasket of the pair of gaskets being a peripherally inner gasket and the other gasket of the pair of gaskets being a peripherally outer gasket, and fasteners positioned between the peripherally inner and outer gaskets securing the lid on the base.

The flanges of the base and lid can have first and second elevations in cross-section. The first elevation can be below and peripherally outward of the second elevation. The fasteners can be quarter-turn bolts.

In another aspect, a casket vault comprises a base adapted to receive therein a casket containing remains of a deceased, the base having a bottom wall, a pair of side walls, and a pair of end walls, a lid closable on the base, and an extension extending peripherally outwardly from one or more of the bottom wall, one (or both) of the side walls, or one (or both) of the end walls to anchor the casket vault in a grave.

The casket vault can include a pair of said extensions, one of the pair of extensions extending laterally outwardly from each of the side walls. Each extension can extend laterally outwardly from a respective one of the side walls near a juncture of the side wall and the bottom wall. Each extension can have a lower surface and an upper surface, the lower surface being flush with a lower surface of the bottom wall, the upper surface being concave in cross-section.

In another aspect, a casket vault comprises a base adapted to receive therein a casket containing remains of a deceased, the base having a bottom wall, a pair of side walls, and a pair of end walls, a lid closable on the base, and a cable ledge extending across each end wall and adapted to receive a length of cable positioned thereunder such that the cable can be used to raise the casket vault.

The base can have rounded corners and the cable ledge can extend across the end wall, around the rounded corners, and along the side walls.

In another aspect, a casket vault comprises a base adapted to receive therein a casket containing remains of a deceased, the base having a bottom wall, a pair of side walls, a pair of end walls, and an upwardly facing flange, a lid closable on the base, the lid having a downwardly facing flange, a pair of wheels mounted to the base facilitating transport of the casket vault, a pair of handles formed in at least one of the base and lid facilitating transport of the casket vault, at least a pair of slots formed in an outward side of a bottom wall of the base adapted to receive and position lowering straps for lowering the casket vault into a grave and for facilitating removal of the straps from the casket vault after the casket vault has been completely lowered into the grave, a memorial record tube assembly disposed in the lid for containing a record of identification of a deceased in the casket vault, a pair of gaskets disposed between the flanges of the base and lid, one gasket of the pair of gaskets being a peripherally inner gasket and the other gasket of the pair of gaskets being a peripherally outer gasket, fasteners positioned between the peripherally inner and outer gaskets securing the lid on said base, an extension extending peripherally outwardly from one or more of the bottom wall, one (or both) of the side walls, and one (or both) of the end walls, and a cable ledge extending across each end wall and adapted to receive a length of cable positioned thereunder such that the cable can be used to raise the casket vault.

### DRAWINGS

FIG. 1 is a perspective view of the casket vault.

FIG. 2 is an enlarged, disassembled, partial perspective view of the casket vault of FIG. 1.

FIG. 3 is a view taken along line 3-3 of FIG. 1.

FIG. 4 is a side view of the casket vault.

FIGS. 5A and 5B are side views of the casket vault being lowered into a grave.

FIG. 6 is and end view of the casket vault in the grave and covered with soil.

FIGS. 7A and 7B are perspective views of alternative embodiments of the casket vault.

FIG. 8 is an enlarged, partial perspective view of another alternative embodiment of the casket vault.

FIG. 8A is the encircled area 8A shown in FIG. 8.

FIG. 9 is a perspective view of another alternative embodiment of the casket vault.

### DESCRIPTION

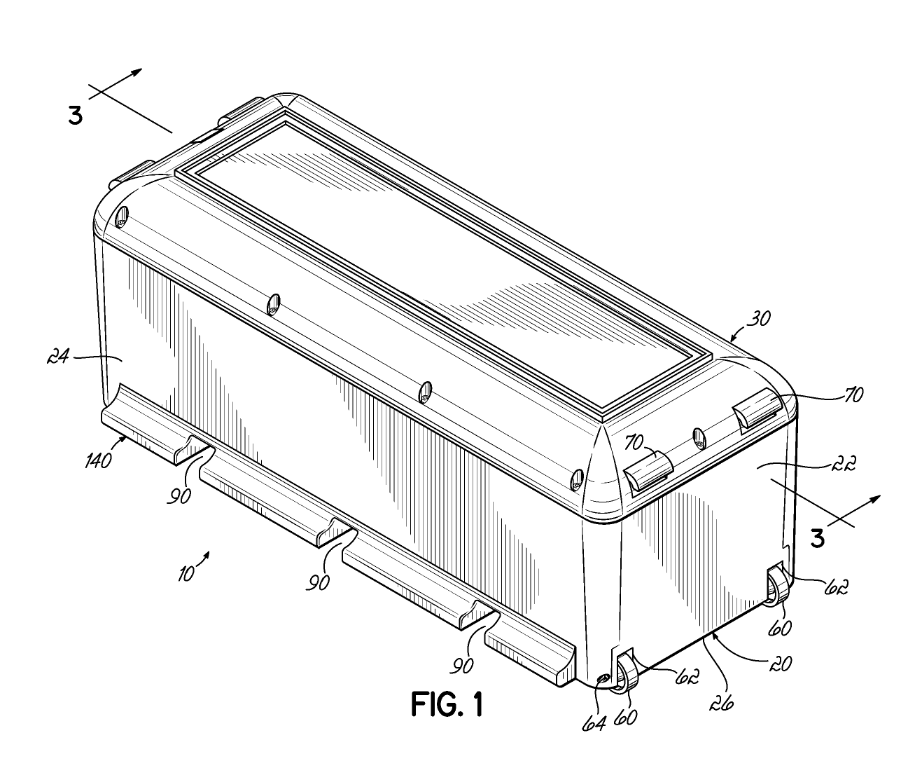

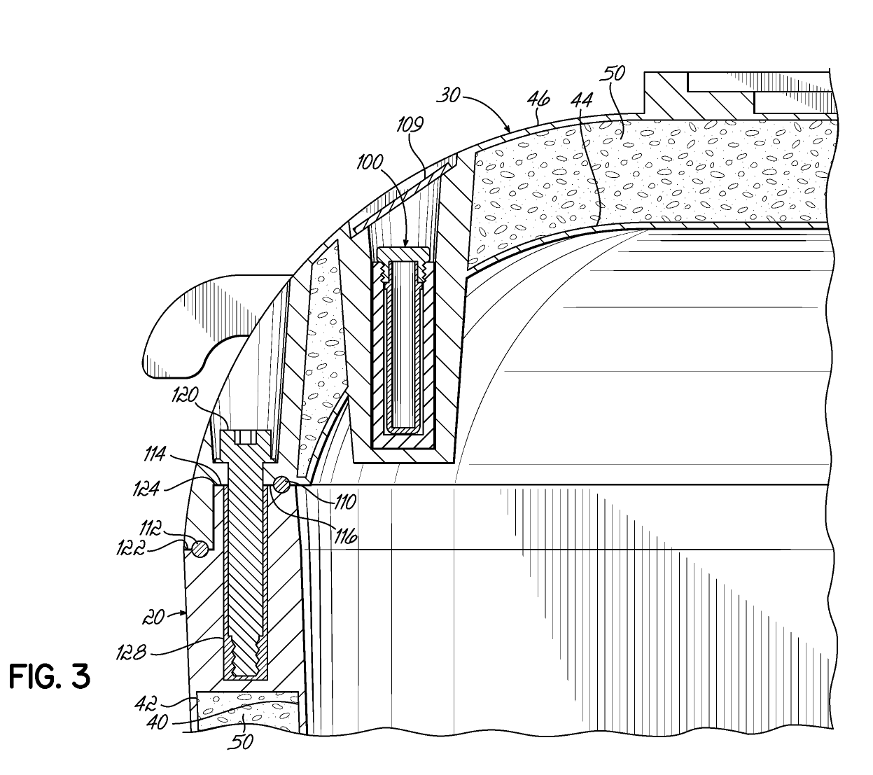

Referring to FIG. 1, a casket vault 10 is illustrated. The vault 10 includes a base 20 adapted to receive a casket (not shown) and a lid 30 closeable on the base 20. The base includes a pair of end walls 22, 22, and pair of side walls 24, 24, and a bottom wall 26. The base 20 and lid can be of a double wall construction, each having an inner wall and an outer wall. With reference to FIG. 3, it will be seen that base 20 includes an inner wall 40 and an outer wall 42, and lid 30 includes an inner wall 44 and an outer wall 46. A structural filler material 50 is disposed between the base inner and outer walls 40, 42 and the lid inner and outer walls 44, 46. The base inner and outer walls 40, 42 and the lid inner and outer walls 44, 46 can be fabricated of a synthetic resinous material, and the structural filler material 50 can be a structural foam. For example, the walls can be fabricated of linear low density polyethylene or polypropylene, and the structural foam can be urethane foam or polyethylene foam. Other suitable materials can be used.

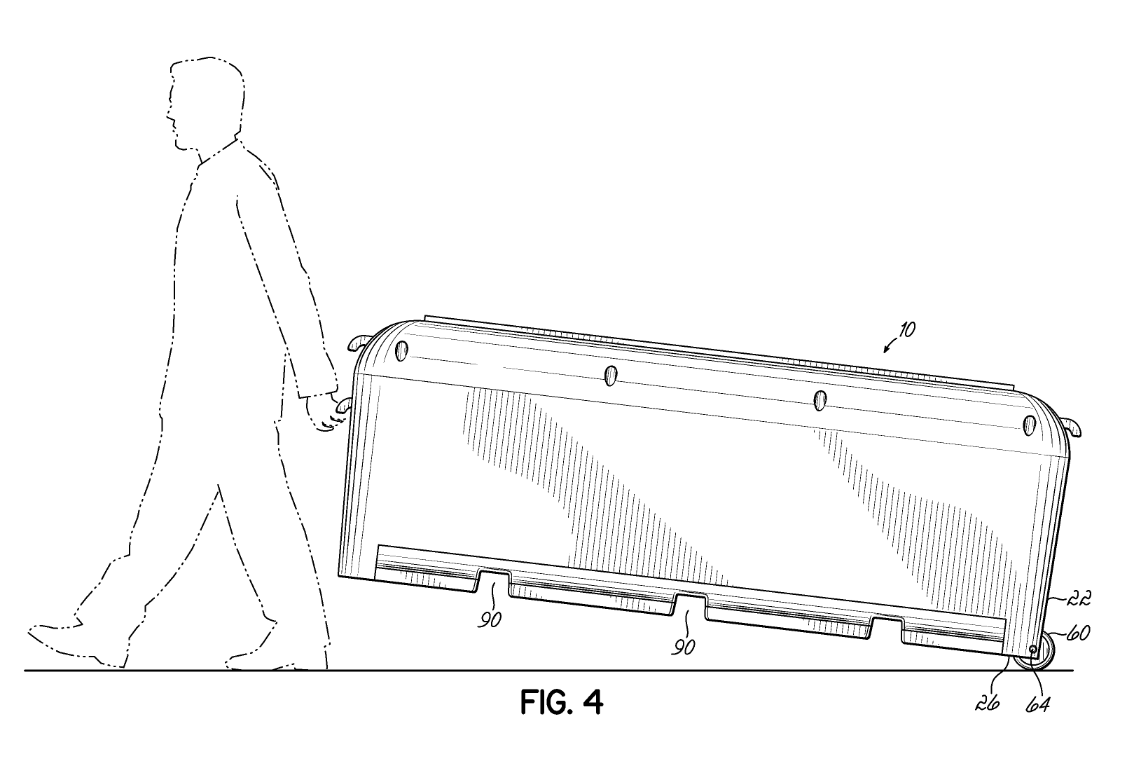

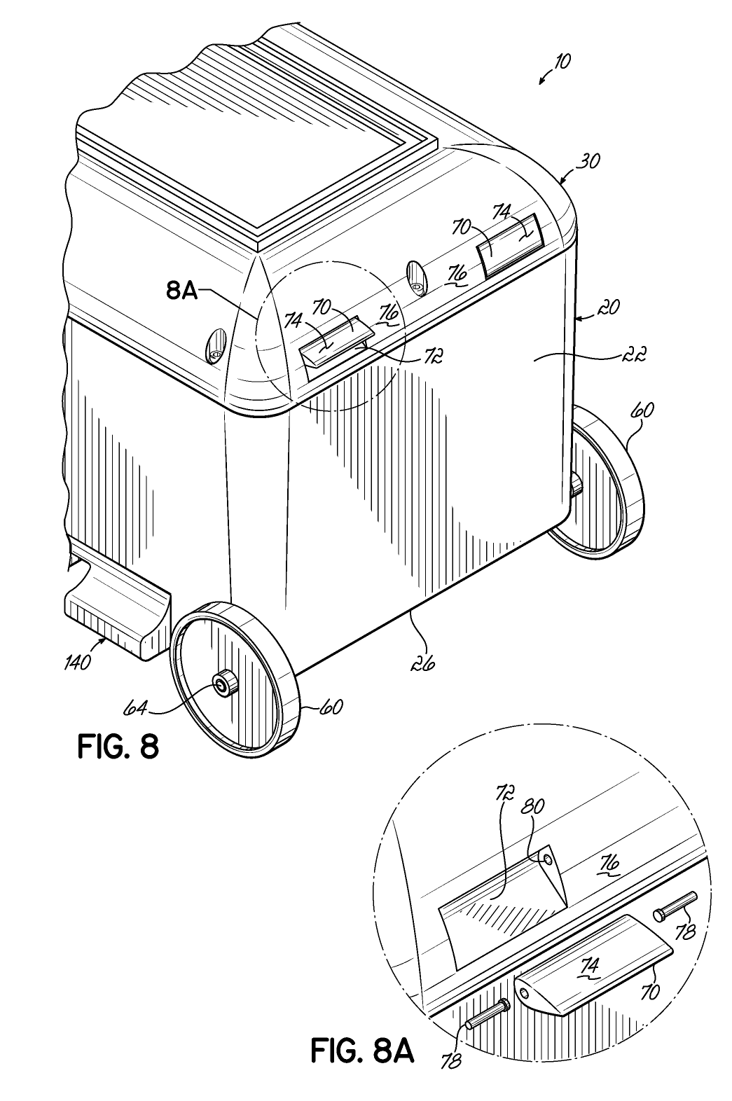

The casket vault 10 can include any or all of a number of features and enhancements. For example, the casket vault 10 can include a pair of wheels 60, 60 to assist in moving the casket vault 10, and in particular to enable a single worker to move the casket vault 10 from the delivery truck to the grave site without using any other equipment. A pair of wheel wells 62, 62 can be formed in one of the end walls 22 and in the bottom wall 24. One wheel 60 of each of the pair of wheels 60, 60 can be mounted in each of the wheel wells 62 via a pin or axle 64. The wheels 60, 60 allow a user to easily transport the unit 10 by lifting the opposite end of the vault 10 and rolling the vault 10. See FIG. 4. Alternatively, the wheels 60, 60 could be mounted outboard of each of the side walls 24, 24. See FIG. 8. This alternative design avoids the need to form the wheel wells 62, 62 and eliminates the resultant diminished interior vault space. It also allows a larger diameter wheel which enhances maneuverability. The delivery attendant could easily attach the wheels 60, 60 at the point of delivery, move the unit to its final destination, and then remove the wheels 60, 60 for use on the next unit to lower the overall product cost.

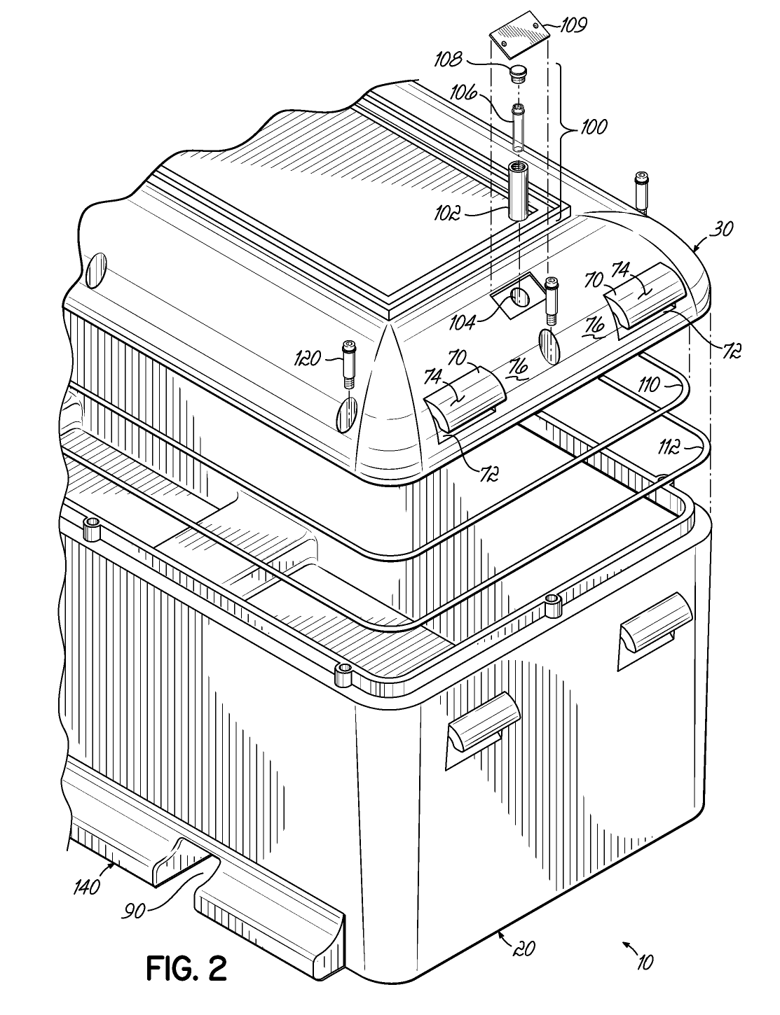

To further enhance maneuverability, one or a pair of handles 70, 70 can be formed in either or both of the base 20 and lid 30. See for example FIGS. 2-4. The handles 70, 70 can be integrally formed as a fixed part of either or both of the base 20 and lid 30, or can be pivoted to either the base 20 or lid 30 so as to pivot into and out of recesses 72 formed in either or both of the base 20 and lid 30. See FIGS. 8 and 8A. For added functionality as well as aesthetics, pivoting handles 70, 70 can have an outward surface contour 74 that matches an outward surface contour 76 of either or both of the base 20 and lid 30 so that when the handles 70 are pivoted into their respective recesses 72 they present a smooth uninterrupted surface appearance. Each handle 70 can be attached within its respective recess 72 by a pair of spring loaded pivot pins 78, 78. A compression spring (not shown) can be loaded into the handle 70 between the two pivot pins 78, 78. To install the handle 70 the ends of the pivot pins 78, 78 are pressed inwardly to allow the handle 70 and pins 78, 78 to be inserted into the recess 72. Once the spring loaded pivot pins 78, 78 reach holes 80, 80 they spring outwardly into the holes 80, 80 to retain the handle 70 in the recess 72. The handle 70 can then be positioned downwardly in the recess 72 so as to be flush with the surrounding surface 74 or pulled upwardly to allow a user to grasp it.

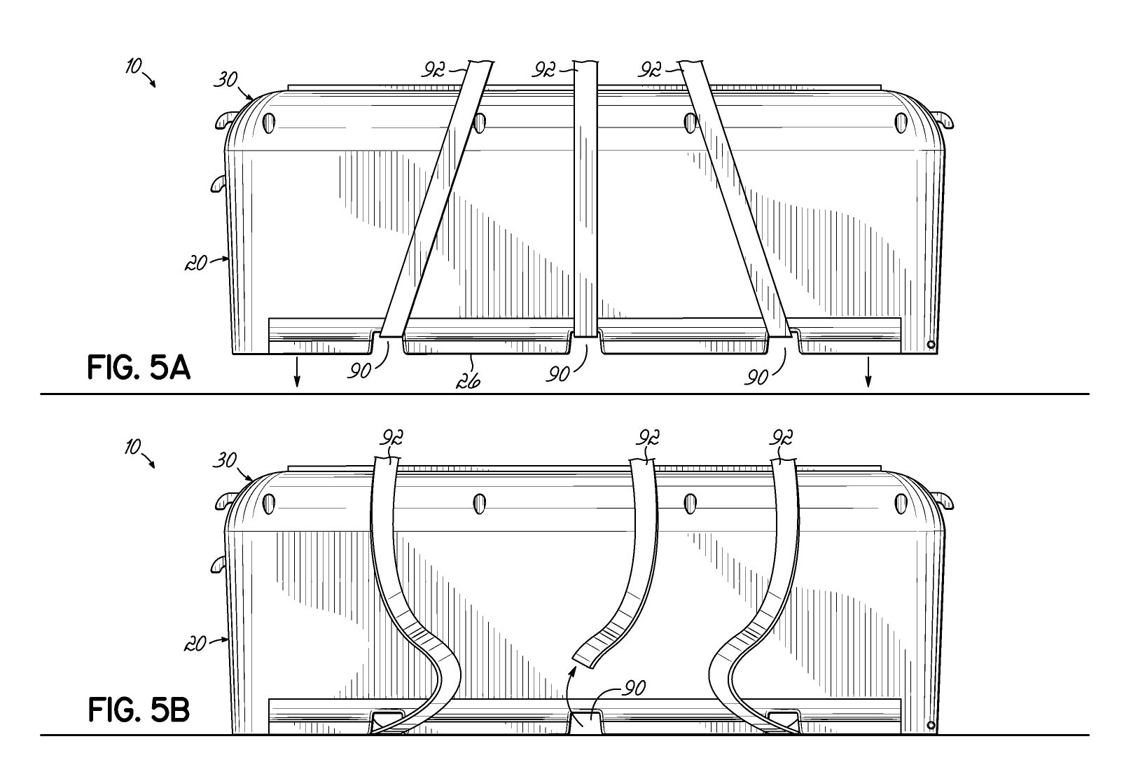

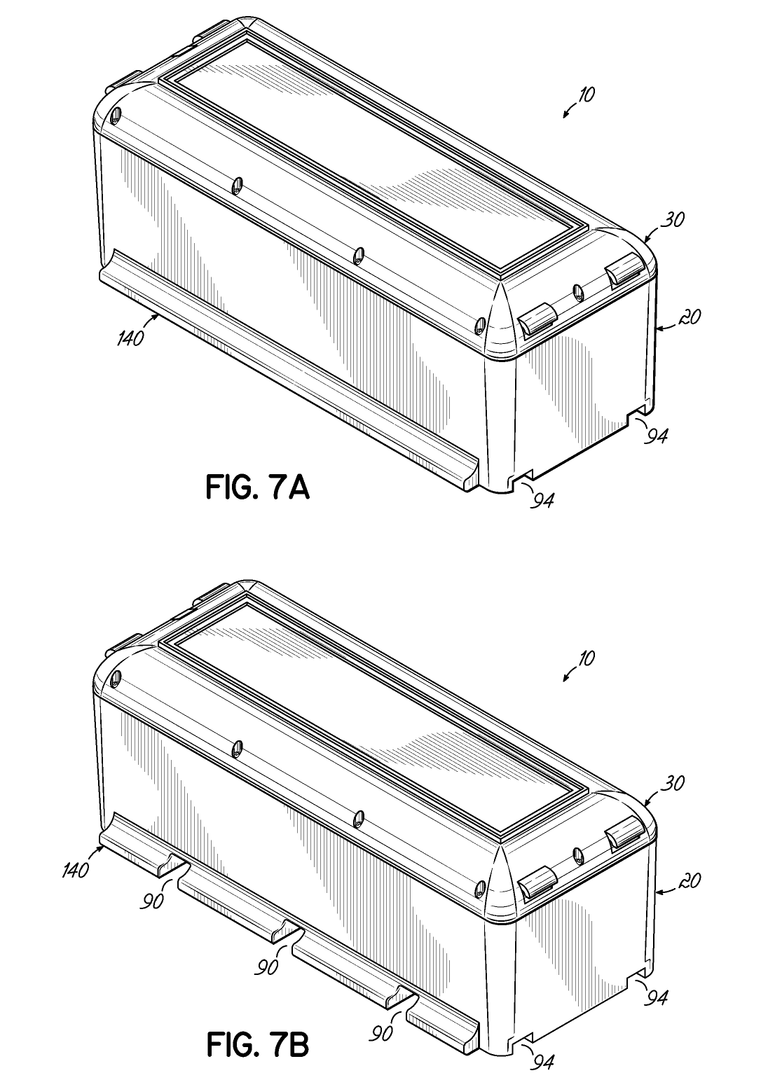

Referring to FIGS. 5A, 5B, 7A, and 7B, slots 90 can be formed in an outward side of the bottom wall 26 of the base 20. The slots 90 are adapted to receive and position lowering straps 92 for lowering the casket vault 10 into a grave and for facilitating removal of the straps 92 from around the casket vault 10 after the casket vault 10 has been completely lowered into the grave. See FIGS. 5A and 5B. Slots 90 eliminate the need to create dirt mounds in the bottom of the grave under the vault to create lifting strap clearance. Slots 90 can run perpendicular to a lengthwise dimension of the casket vault 10 as shown in FIGS. 5A and 5B, or slots 94 can run parallel to the lengthwise dimension of the casket vault 10 as shown in FIG. 7A, or the casket vault 10 can have both slots 90 running perpendicular to the lengthwise dimension of the casket vault 10 and slots 94 running parallel to the lengthwise dimension of the casket vault 10 as shown in FIG. 7B.

Referring back to FIG. 2, a memorial record tube assembly 100 can be disposed in the lid 20 of the casket vault 10 to contain a record of the identity of the deceased in the casket vault 10. Memorial record tube assembly 100 can comprise a cylinder 102 disposed in a recess 104 in the lid 30, and a memorial record tube 106 including a threaded cap 108 disposed in the cylinder 102. A nameplate 109, for example an engraveable nameplate, can overlie the memorial record tube assembly 100.

Referring to FIGS. 2 and 3, the casket vault 10 can include a pair of gaskets 110, 112 disposed between the upwardly facing flange 114 of the base 20 and the downwardly facing flange 116 of the lid 30. Gasket 110 is a peripherally inner gasket whereas gasket 112 is a peripherally outer gasket. Fasteners 120 are positioned between the peripherally inner gasket 110 and the peripherally outer gasket 112 and secure the lid 30 to the base 20. As shown in FIG. 3, the abutting flange surfaces of the upwardly facing flange 114 of the base 20 and the downwardly facing flange 116 of the lid 30 have first 122 and second 124 elevations. The first elevation 122 is below and peripherally outward of the second elevation 124. The inner gasket 110 is positioned at the second elevation 124 and the second gasket 112 is positioned at the first elevation 122. The fasteners 120 can be quarter-turn hex head bots which thread into threaded inserts 128. Gaskets 110, 112 can be fabricated of EPDM, natural rubber, or a pliable mastic material. Other suitable materials can be used.

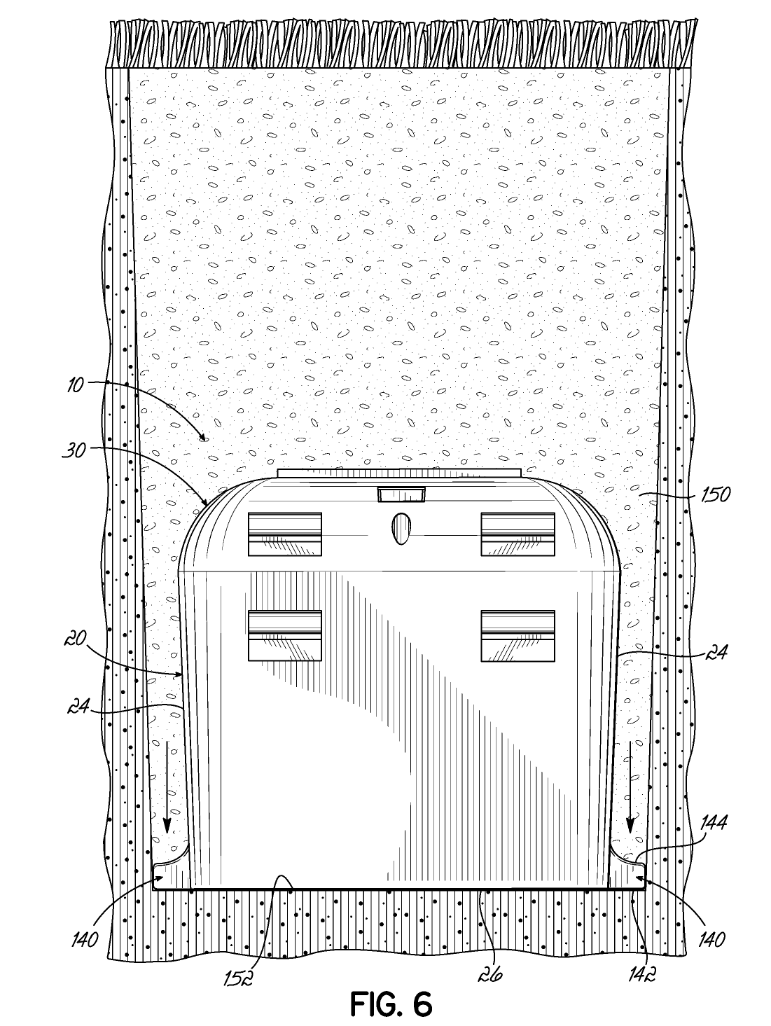

Referring now to FIG. 6, the casket vault 10 can include one or more extensions or wings 140 extending peripherally outwardly from one or more of the bottom wall 26, one or both of the side walls 24, and one or both of the end walls 22. As illustrated casket vault 10 has a pair of extension 140 extending laterally outwardly from each side wall 24. More particularly, each extension 140 extends laterally outwardly from a respective one of the side walls 54 near a juncture of the side wall 24 and the bottom wall 26. Each extension 140 has a lower surface 142 and an upper surface 144. The lower surface 142 is flush with a lower surface of bottom wall 26 and the upper surface is concave in cross-section. The wings 140 provide an anchor for the soil 150 to anchor the casket vault 10 against the bottom 152 of the grave and prevent the casket vault 10 from rising during floods or ground freezing.

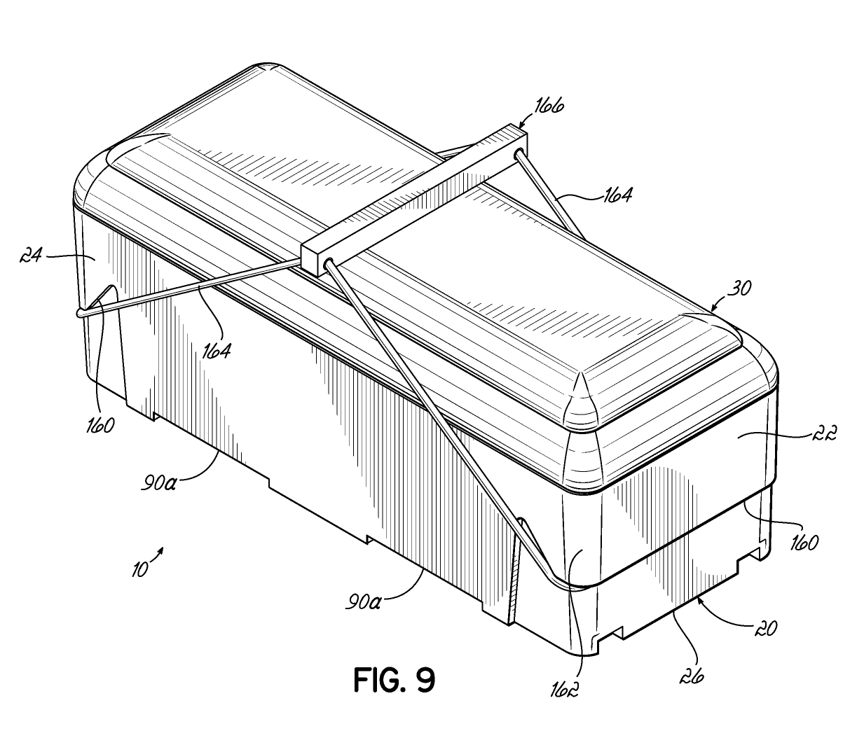

Referring now to FIG. 9, the casket vault 10 is shown as incorporating a cable ledge 160 on both ends of the base 20. Cable ledge 160 extends across the end wall 22, around the end wall/side wall corner 162, and partially along side wall 24. Cable ledges 160, 160 permit a cable 164 of a cable attachment 166 to lift casket vault 10 out of the ground in the event of a need to disinter the casket vault 10. Also, this embodiment illustrates the use of a pair of wider transverse slots 90a, 90a to accommodate the forks of a fork lift as an alternative means of moving the casket vault 10.

The embodiments shown and described are merely for illustrative purposes only. The drawings and the description are not intended to limit in any way the scope of the claims. Those skilled in the art will appreciate various changes, modifications, and other embodiments. All such changes, modifications and embodiments are deemed to be embraced by the claims. Accordingly, the scope of the right to exclude shall be limited only by the following claims and their equivalents.

What is claimed is:

1. A casket vault comprising:
a base adapted to receive therein a casket containing remains of a deceased,
a lid closable on said base, and
a pair of wheels mounted to said base facilitating transport of said casket vault.

2. The casket vault of claim 1 wherein said base and lid are of a double wall construction each having an inner wall and an outer wall.

3. The casket vault of claim 2 wherein said base and lid have a structural filler material between said inner and outer walls.

4. The casket vault of claim 3 wherein said inner and outer walls of said base and lid are fabricated of a synthetic resinous material.

5. The casket vault of claim 4 wherein said structural filler material is structural foam.

6. The casket vault of claim 5 wherein said base includes an end wall and a bottom wall, a pair of wheel wells are formed in said end and bottom walls, and one of said pair of wheels is mounted in each of said wheel wells.

7. The casket vault of claim 5 wherein said base includes a pair of side walls, an end wall, and a bottom wall, and one of said pair of wheels is mounted outboard of each of said side walls.

8. A casket vault comprising:
a base adapted to receive therein a casket containing remains of a deceased,
a lid closable on said base, and
a pair of handles formed in at least one of said base and lid facilitating transport of said casket vault.

9. The casket vault of claim 8 wherein said base and lid are of a double wall construction each having an inner wall and an outer wall.

10. The casket vault of claim 9 wherein said base and lid have a structural filler material between said inner and outer walls.

11. The casket vault of claim 10 wherein said inner and outer walls of said base and lid are fabricated of a synthetic resinous material.

12. The casket vault of claim 11 wherein said structural filler material is structural foam.

13. The casket vault of claim 12 wherein said handles are integrally formed as a fixed part of said at least one of said base and lid.

14. The casket vault of claim 12 wherein said handles are pivoted to said at least one of said base and lid.

15. The casket vault of claim 14 wherein said handles pivot into and out of recesses formed in said at least one of said base and lid.

16. The casket vault of claim 15 wherein said handles have an outward surface contour that matches an outward surface contour of said at least one of said base and lid when said handles are pivoted into said recesses.

17. A casket vault comprising:
a base adapted to receive therein a casket containing remains of a deceased,
a lid closable on said base, and
at least a pair of slots formed in an outward side of a bottom wall of said base adapted to receive and position lowering straps for lowering said casket vault into a grave and for facilitating removal of the straps from said casket vault after said casket vault has been completely lowered into the grave.

18. The casket vault of claim 17 wherein said base and lid have a structural filler material between said inner and outer walls.

19. The casket vault of claim 18 wherein said inner and outer walls of said base and lid are fabricated of a synthetic resinous material.

20. The casket vault of claim 19 wherein said structural filler material is structural foam.

21. The casket vault of claim 20 wherein said slots run perpendicular to a lengthwise dimension of said of casket vault.

22. The casket vault of claim 21 wherein there are three said slots.

23. The casket vault of claim 20 wherein said slots run parallel to a lengthwise dimension of said of casket vault.

24. The casket vault of claim 23 wherein there are two said slots.

25. The casket vault of claim 20 wherein said slots run perpendicular to a lengthwise dimension of said of casket vault and parallel to the lengthwise dimension of said of casket vault.

26. The casket vault of claim 25 wherein there are three said slots running perpendicular to the lengthwise dimension of said of casket vault and two said slots running parallel to the lengthwise dimension of said of casket vault.

27. A casket vault comprising:
a base adapted to receive therein a casket containing remains of a deceased,
a lid closable on said base, and
a memorial record tube assembly disposed in said lid for containing a record of identification of a deceased in said casket vault.

28. The casket vault of claim 27 wherein said base and lid have a structural filler material between said inner and outer walls.

29. The casket vault of claim 28 wherein said inner and outer walls of said base and lid are fabricated of a synthetic resinous material.

30. The casket vault of claim 29 wherein said structural filler material is structural foam.

31. The casket vault of claim 30 wherein said memorial record tube assembly comprises a cylinder disposed in said lid, a memorial record tube including a threaded cap disposed in said cylinder, and a nameplate overlying said memorial record tube assembly.

32. A casket vault comprising:
a base adapted to receive therein a casket containing remains of a deceased, said base having an upwardly facing flange,
a lid closable on said base, said lid having an downwardly facing flange,
a pair of gaskets disposed between said flanges of said base and lid, one gasket of said pair of gaskets being a peripherally inner gasket and the other gasket of said pair of gaskets being a peripherally outer gasket, and
fasteners positioned between said peripherally inner and outer gaskets securing said lid on said base.

33. The casket vault of claim 32 wherein said base and lid have a structural filler material between said inner and outer walls.

34. The casket vault of claim 33 wherein said inner and outer walls of said base and lid are fabricated of a synthetic resinous material.

35. The casket vault of claim 34 wherein said structural filler material is structural foam.

36. The casket vault of claim 35 wherein said flanges of said base and lid have first and second elevations in cross-section, the first elevation being below and peripherally outward of the second elevation.

37. The casket vault of claim 36 wherein said peripherally inner gasket is positioned at the second elevation and said peripherally outer gasket is positioned at the first elevation.

38. The casket vault of claim 37 wherein the fasteners are quarter-turn bolts.

39. A casket vault comprising:
a base adapted to receive therein a casket containing remains of a deceased, said base having a bottom wall, a pair of side walls, and a pair of end walls,
a lid closable on said base, and
an extension extending peripherally outwardly from at least one of: a) said bottom wall, b) at least one of said pair of side walls, and c) at least one of said pair of end walls to anchor said casket vault in a grave.

40. The casket vault of claim 39 wherein said base and lid have a structural filler material between said inner and outer walls.

41. The casket vault of claim 40 wherein said inner and outer walls of said base and lid are fabricated of a synthetic resinous material.

42. The casket vault of claim 41 wherein said structural filler material is structural foam.

43. The casket vault of claim 42 including a pair of said extensions, one of said pair of extensions extending laterally outwardly from each said side wall.

44. The casket vault of claim 43 wherein each said extension extends laterally outwardly from a respective one of said side walls near a juncture of said side wall and said bottom wall.

45. The casket vault of claim 44 wherein each said extension has a lower surface and an upper surface, said lower surface being flush with a lower surface of said bottom wall, said upper surface being concave in cross-section.

46. A casket vault comprising:
a base adapted to receive therein a casket containing remains of a deceased, said base having a bottom wall, a pair of side walls, and a pair of end walls,
a lid closable on said base, and
a cable ledge extending across each said end wall and adapted to receive a length of cable positioned thereunder such that the cable can be used to raise said casket vault.

47. The casket vault of claim 46 wherein said base and lid have a structural filler material between said inner and outer walls.

48. The casket vault of claim 47 wherein said inner and outer walls of said base and lid are fabricated of a synthetic resinous material.

49. The casket vault of claim 48 wherein said structural filler material is structural foam.

50. The casket vault of claim 49 wherein said base has rounded corners, and wherein said cable ledge extends across said end wall, around said rounded corners, and along said side walls.

51. A casket vault comprising:
a base adapted to receive therein a casket containing remains of a deceased, said base having a bottom wall, a pair of side walls, a pair of end walls, and an upwardly facing flange,
a lid closable on said base, said lid having an downwardly facing flange,
a pair of wheels mounted to said base facilitating transport of said casket vault,
a pair of handles formed in at least one of said base and lid facilitating transport of said casket vault,
at least a pair of slots formed in an outward side of a bottom wall of said base adapted to receive and position lowering straps for lowering said casket vault into a grave and for facilitating removal of the straps from said casket vault after said casket vault has been completely lowered into the grave,
a memorial record tube assembly disposed in said lid for containing a record of identification of a deceased in said casket vault,
a pair of gaskets disposed between said flanges of said base and lid, one gasket of said pair of gaskets being a peripherally inner gasket and the other gasket of said pair of gaskets being a peripherally outer gasket,
fasteners positioned between said peripherally inner and outer gaskets securing said lid on said base,
an extension extending peripherally outwardly from at least one of: a) said bottom wall, b) at least one of said pair of side walls, and c) at least one of said pair of end walls, and
a cable ledge extending across each said end wall and adapted to receive a length of cable positioned thereunder such that the cable can be used to raise said casket vault.

52. The casket vault of claim 51 wherein said base and lid have a structural filler material between said inner and outer walls.

53. The casket vault of claim 52 wherein said inner and outer walls of said base and lid are fabricated of a synthetic resinous material.

54. The casket vault of claim 53 wherein said structural filler material is structural foam.
